(19) United States
(12) Patent Application Publication
(10) Pub. No.: US 2007/0006405 A1
(43) Pub. Date: Jan. 11, 2007

(54) Systems and methods for wafer cleaning

(75) Inventors: Hsien-Ping Feng, Yonghe City (TW); Min-Yuan Cheng, Taipei City (TW); Jia-Jia Lin, Chia-yi County (TW); Chieh-Tsao Wang, Jhubei City (TW); Shu-Wen Fu, Hsinchu City (TW); Steven Lin, Chu-Dong Jeng (TW); Ray Chuang, Taipei (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(73) Assignee: Taiwan Semiconductor Manufacturing Co., Ltd.

(21) Appl. No.: 11/176,767

(22) Filed: Jul. 7, 2005

(51) Int. Cl. B08B 1/04

(52) U.S. Cl. 15/77; 15/88.3

(57) ABSTRACT

A wafer cleaning system is provided. The wafer cleaning system comprises a first brush, a second brush, a brush motor, and a controller. The second brush is positioned parallel to the first brush. The brush motor moves at least one of the first and second brushes from a first position to a second position according to a driving current of the brush motor.

### BACKGROUND

The present invention relates generally to semiconductor manufacturing and more particularly to a system for cleaning wafers.

Polishing slurries used for planarization processes, such as chemical-mechanical polishing (CMP) processes, are typically aqueous suspensions, comprising metal oxide abrasive, organic acids, surfactants, and a suitable oxidizing agent. The oxidizing agent enhances mechanical removal of material via a corrosion assisted process. Such oxidizing agents employed in commercially available or proprietary slurries are typically inorganic metal salts such as FeNO₃, or KIO₃, and also hydrogen peroxide. Other chemicals, such as organic acids, are added-to slurries to improve dispersion and/or enhance performance. Sodium, potassium, and iron salts and/or compounds are frequently used in slurry formulations, and significant measurements of these metal ion impurities remain on the wafer after polishing and post-polish cleaning. The particulate materials are extremely difficult to remove without adversely affecting the polished surface.

FIG. 1A illustrates a brush assembly employed in a conventional post-CMP cleaning process. FIG. 1A illustrates a simplified three dimensional diagram of a pair of brushes 120a and 120b for scrubbing a top surface and a bottom surface, respectively, of a wafer 130. Typically, the wafer 130 is caused to rotate in a particular direction while the brushes 120a and 120b roll around an axis, and the surfaces of the brushes 120a and 120b press against the surfaces of the wafer 130. The brushes 120a and 120b are mounted on brush cores 100a and 100b, respectively. Brushes 120a and 120b are generally made of (polyvinyl alcohol) PVA, and expand during the lifetime thereof. Typically, positions of brush cores 100a and 100b are fixed during the lifetime of the brushes 120a and 120b. As the brushes expand, the surfaces of the brushes 120a and 120b exert increased pressure on the wafer 130. Referring to FIGS. 1B and 1C, the distance between brush cores 100a and 100b is d. In FIG. 1C, brushes 120a and 120b expand, and more pressure is exerted on wafer 130. Additionally, as the brushes exert increased pressure on the wafer surface, severe particulate contamination may occur.

### SUMMARY

Wafer cleaning systems are provided. An exemplary embodiment of a wafer cleaning system comprises: a first brush; a second brush; a brush motor, and a controller. The second brush is positioned parallel to the first brush. The brush motor rolls the first and second brushes, respectively. The controller moves at least one of the first and second brushes from a first position to a second position according to a driving current of the brush motor.

Workpiece processing methods are provided. An exemplary embodiment of a workpiece is cleaned with a pair of rolling brushes positioned at a first position. A measurement of a driving current is received, wherein the driving current is utilized to roll the brush when it is at the first position. A preset schedule is provided, specifying the relationship between the driving current and the distance between the outer surfaces of the first and second brushes. A second brush position is determined according to the measurement of the driving current and the preset schedule. The brushes are moved from the first position to the second position. The workpiece is cleaned with the pair of rolling brushes positioned at the second position.

Methods for controlling a brush assembly are also provided. An exemplary embodiment of a brush assembly used for wafer cleaning comprises a pair of brushes positioned at a first position rolling when cleaning a wafer. A preset schedule is provided, specifying the relationship between the driving current and the distance between the outer surfaces of the first and second brushes. A measurement of a driving current is received, wherein the driving current utilized to roll the brush when it is at the first position. A second position for the pair of brushes is determined according to the measurement of the driving current and the preset schedule.

The method for controlling a brush assembly may take the form of program code embodied in a tangible media. When the program code is loaded into and executed by a machine, the machine becomes a system for practicing embodiments of the invention.

A detailed description is given in the following embodiments with reference to the accompanying drawings.

### BRIEF DESCRIPTION OF THE DRAWINGS

The present invention can be more fully understood by reading the subsequent detailed description and examples with references made to the accompanying drawings, wherein:

FIGS. 1A to 1C illustrate a brush assembly and a wafer processed by a conventional wafer cleaning process;

FIG. 2 is a schematic view of an embodiment of a manufacturing system;

FIG. 3A illustrates a simplified three dimensional diagram of a pair of brushes;

FIG. 3B is a partial frontal view of an embodiment of a scrubbing cleaner; and

FIG. 4 is a flowchart of an embodiment of a method of wafer cleaning.

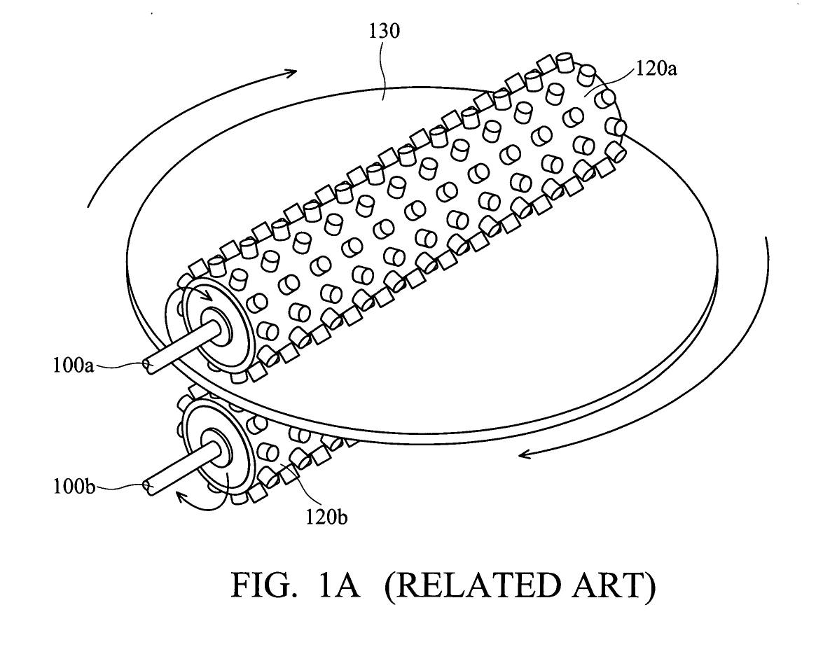

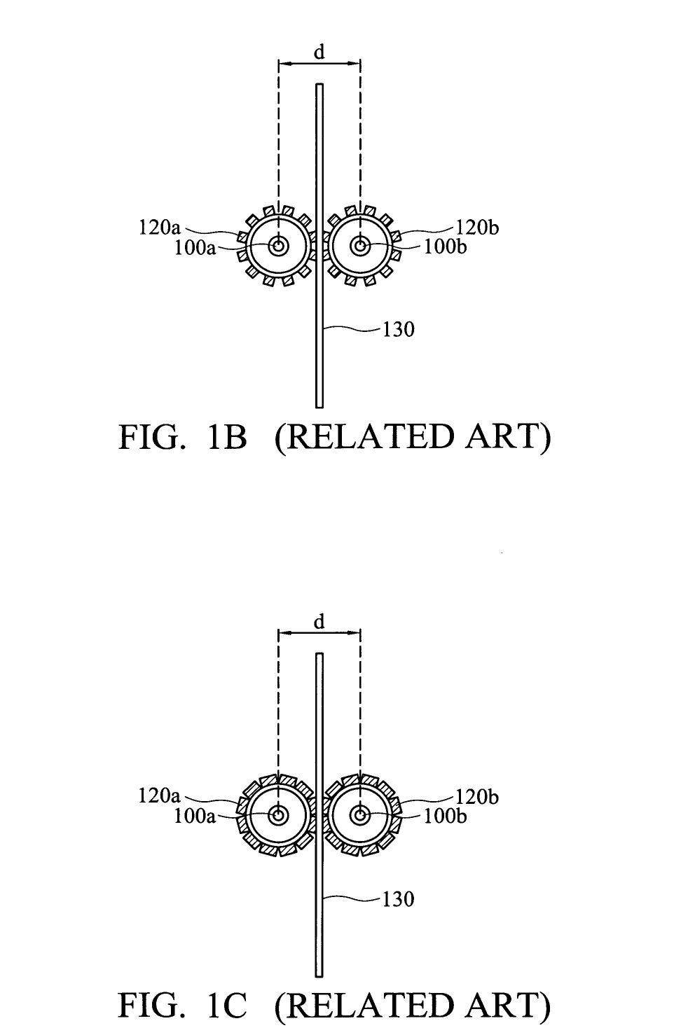

### DETAILED DESCRIPTION

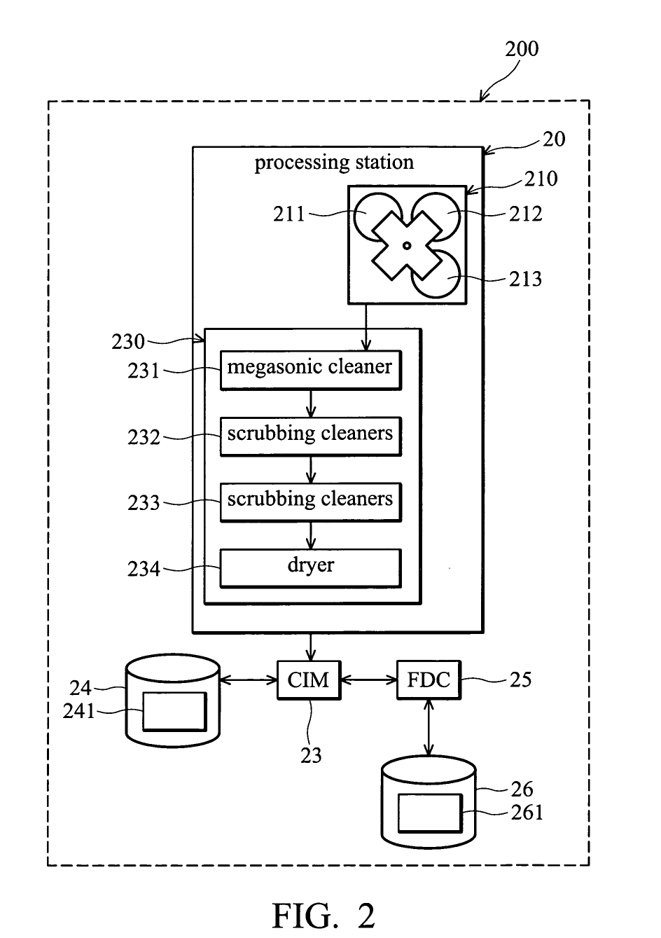

The present invention will now be described with reference to FIGS. 2 to 4, which generally relate to a manufacturing system implementing a method for operating a brush assembly.

In the following detailed description, reference is made to the accompanying drawings which form a part hereof, and in which is shown by way of illustration of specific embodiments. These embodiments are described in sufficient detail to enable those skilled in the art to practice the invention, and it is to be understood that other embodiments may be utilized and that structural, logical and electrical changes may be made without departing from the spirit and scope of the present invention. The following detailed description is, therefore, not to be taken in a limiting sense. The leading digit(s) of reference numbers appearing in the Figures corresponds to the Figure number, with the exception that the same reference number is used throughout to refer to an identical component which appears in multiple Figures.

FIG. 2 is a schematic view of an embodiment of a manufacturing system according to the invention. Manufacturing system 200 is a semiconductor manufacturing system performing CMP and cleaning processes on a semiconductor wafer.

The manufacturing system 200 comprises a processing station 20, a Computer Integrated Manufacturing system (CIM) 23, and a Fault Detection Control system (FDC) 25. The CIM 23 and FDC 25 connect to databases 24 and 26, respectively.

The processing station 20 performs a CMP process and a post-CMP cleaning process, comprising a CMP tool 210 and a cleaning tool 230.

The CMP tool 210 comprises platens 211˜213. Platens 211, 212, and 213 are used for different CMP stages, wherein different types of polishing slurry and different processing recipes are used in those different CMP stages. For example, a first CMP stage is performed at platen 211, wherein a buck of material, such as Cu, is removed. An eddy current endpoint mechanism is used in the first stage for detecting a process endpoint. A second CMP stage is performed at platen 212, wherein a lower down force is implemented, and the wafer surface is further polished. An i-scan endpoint mechanism is used in the second stage for detecting a process endpoint. A third CMP stage is performed at platen 213, wherein a final polishing is performed. A processing time mechanism is used in the third stage for determining a process endpoint.

The cleaning tool 230 comprises a megasonic cleaner 231, scrubbing cleaners 232 and 233, and a dryer 234. The megasonic cleaner 231 performs a cleaning process on a wafer using a megasonic mechanism after the wafer is processed by the CMP tool 210. The scrubbing cleaners 232 and 233 perform a wafer cleaning process using a brush assembly, respectively. The structure and operation of the scrubbing cleaners 232 and 233 are detailed in the following. The dryer 234 uses isopropyl alcohol (IPA) drying mechanism to remove water and moisture from the wafer processed by the megasonic cleaner 231 and scrubbing cleaners 232 and 233.

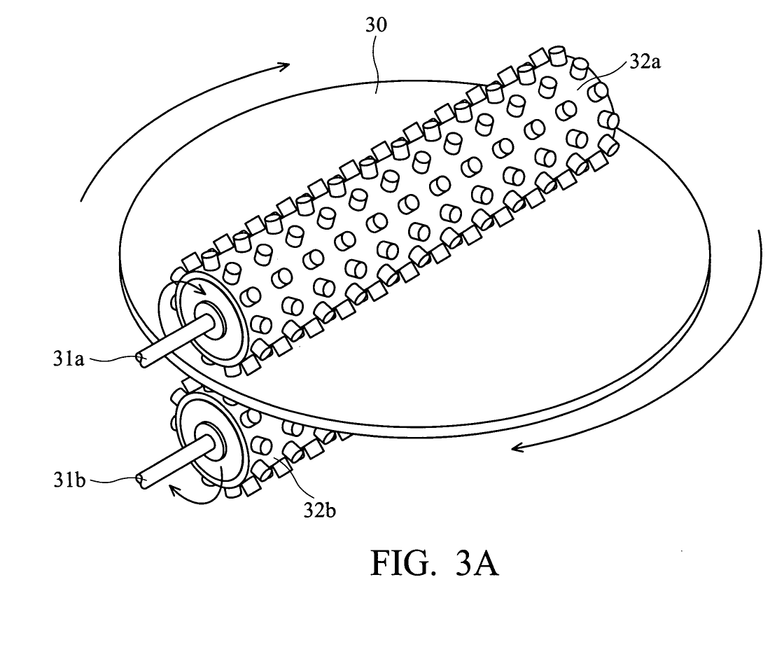

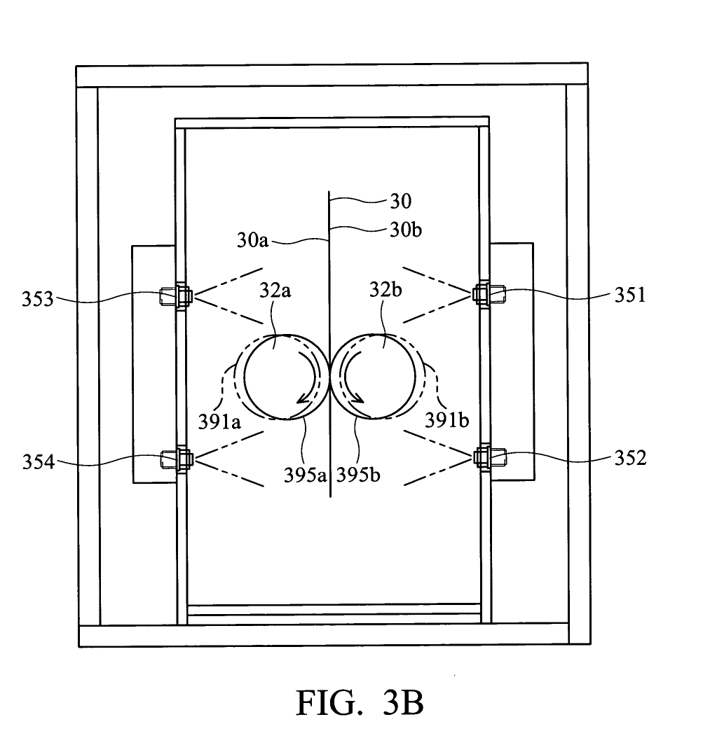

FIG. 3A illustrates a simplified three dimensional diagram of a pair of brushes 32a and 32b for scrubbing a top surface and a bottom surface, respectively, of a wafer 30. Typically, the wafer 30 is caused to rotate in a particular direction while the brushes 32a and 32b roll around an axis, and the surfaces of the brushes 32a and 32b press against the surfaces of the wafer 30. The brushes 32a and 32b are mounted on brush cores 31a and 31b, respectively. The brushes are generally made of (polyvinyl alcohol) PVA, and expand during the lifetime thereof. Rolling of the brushes 320a and 320b is driven by a driving current. Measurement of the driving current used during the cleaning processes is obtained and stored by the scrubbing cleaners 232 and 233, respectively. The measurement is transmitted to CIM 23, and stored in database 24 as record 241. The FDC 25 periodically retrieves the record 241 from the database 24 via the CIM 23. A preset schedule 261 is stored in database 26, specifying the relationship between the driving current and the distance between the pair of brushes. The FDC 25 calculates an average of driving current for measurements obtained during processing of each wafer within a lot, and controls the positioning of the pair of brushes according to the average and the preset schedule 261.

FIG. 3B is a partial frontal view of an embodiment of a scrubbing cleaner of the invention. As shown in FIG. 3B, initially brushes 32a and 32b are at positions 391a and 391b, respectively (indicated by dashed circles). Wafer 30 is then inserted vertically between brushes 32a and 32b by a robotic arm (not shown). Brushes 32a and 32b are then moved towards each other to positions 395a and 395b, respectively. Typically, brushes 32a and 32b move approximately 0.5 inches between positions 391a and 395a, 391b and 395b, respectively. At positions 395a and 395b, brushes 32a and 32b contact first and second surfaces 30a and 30b, respectively, of wafer 30. The level of the driving current for rolling brushes 32a and 32b is proportional to perpendicular component of force (force exerted perpendicular to planes formed by surfaces 30a and 30b of wafer 30) exerted by brush 32a (and brush 32b) on wafer 30.

As shown in FIG. 3B, brush 32a is rotated clockwise and brush 32b is rotated counterclockwise. A plurality of spray nozzles, such as spray nozzles 351, 352, 353, and 354, spray liquid on brushes 32a and 32b, and wafer 30, respectively. The liquid can be a surfactant and/or be de-ionized water. The combination of the scrubbing action on the surfaces 30a and 30b of wafer 30 caused by the rotation of brushes 32a and 32b along with liquid supplied through spray nozzles 351˜354, removes particulates from surfaces 30a, 30b of wafer 30. In particular, particulates are scrubbed from surfaces 30a and 30b by brushes 32a and 32b, respectively. These particulates are flushed from brushes 32a and 32b by the liquid supplied to brushes 32a and 32b through brush cores 31a and 31b. Further, particulates which are loosened by the scrubbing action of brushes 32a and 32b, but remain on surfaces 30a and 30b of wafer 30, are flushed from surfaces 30a and 30b by liquid sprayed from sets of spray nozzles. By orienting wafer 30 vertically instead of horizontally, the removal of particulates from the surfaces 30a and 30b is enhanced.

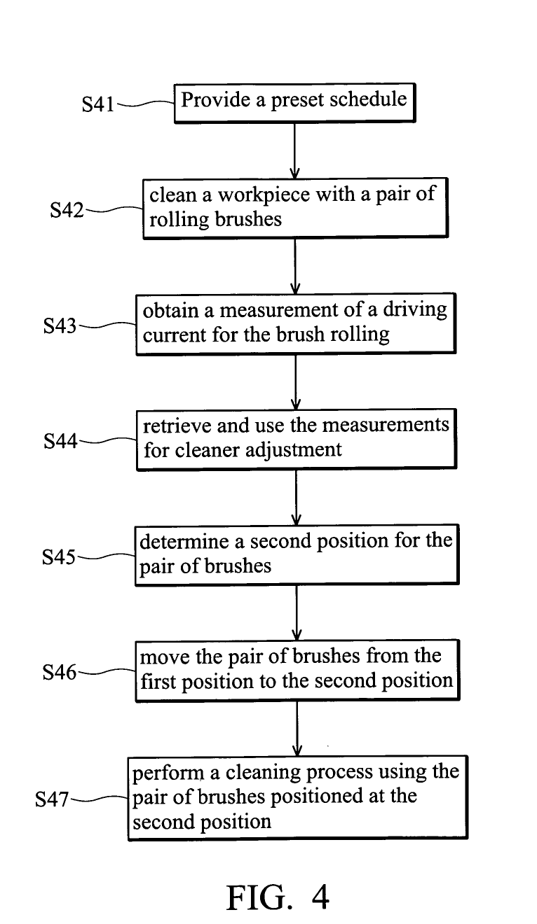

FIG. 4 is a flowchart of an embodiment of a method of the invention.

First, a preset schedule is provided, specifying the relationship between the driving current and the distance between the outer surfaces of the first and second brushes (step S41). The preset schedule can be determined by experimenting and/or historical process data recorded during previous processes.

In step S42, a workpiece is cleaned with a pair of rolling brushes, wherein the pair of the brushes is positioned at a first position.

During the cleaning process, a measurement of a driving current for the brush rolling is obtained when the pair of brushes is positioned at the first position (step S43). The measurement is obtained by a cleaning tool, transferred to and stored in a CIM system. The CIM system stores measurements obtained during a plurality of process runs in a database. The stored measurements are retrieved from the CIM system, and used for cleaner adjustment periodically. Typically, a cleaning brush, such as a PVA brush, undergoes cleaning processes for 400˜500 wafers before it is severely worn. The texture and size of the brush changes during its lifetime, causing changes in a downward pressure exerted on a workpiece. Here, the data retrieval and cleaner adjustment can be performed at a lower frequency during the early in the life of the brush, and a higher frequency later in the life of the brush.

In step S44, stored measurements are retrieved from the CIM system, and used for cleaner adjustment. In step S45, a second position for the pair of brushes is determined according to the preset schedule and the retrieved measurements. Moving the pair of brushes from the first position to the second position compensates for brush wear. In step S46, the pair of brushes is moved from the first position to the second position. In step S47, a cleaning process is performed using the pair of brushes positioned at the second position.

While the invention has been described by way of example and in terms of preferred embodiment, it is to be understood that the invention is not limited thereto. Those skilled in this technology can still make various alterations and modifications without departing from the scope and spirit of this invention. Therefore, the scope of the present invention shall be defined and protected by the following claims and their equivalents.

What is claimed is:

1. A wafer cleaning system, comprising:
a first brush;
a second brush, positioned parallel to the first brush;
a brush motor rolling the first and second brushes; and
a controller moving at least one of the first and second brushes from a first position to a second position according to a driving current of the brush motor.

2. The wafer cleaning system of claim 1, wherein the first and second brushes comprise a brush body made of a sponge material, respectively.

3. The wafer cleaning system of claim 2, wherein the first and second brushes comprise a brush body made of polyvinyl alcohol (PVA).

4. The wafer cleaning system of claim 1, further comprising a first brush positioner moving the first brush, and a second brush positioner moving the second brush.

5. The wafer cleaning system of claim 4, wherein the controller receives a measurement of the driving current utilized in processing a plurality of wafers, calculates an average of the received measurement, and directs the first and second brush positioners according to the average and the preset schedule.

6. The wafer cleaning system of claim 1, wherein the schedule comprises a standard driving current corresponding to a preset pressure exerted by the first and second brushes on a processed wafer.

7. The wafer cleaning system of claim 1, wherein the schedule specifies relations between the driving current and the distance between the outer surfaces of the first and second brushes.

8. A method of workpiece processing, comprising:
cleaning a workpiece with a pair of rolling brushes positioned at a first position;
receiving a measurement of a driving current for rolling the brushes at the first position;
providing a preset schedule specifying relations between the driving current and the distance between the first and second brushes;
determining a second position for the pair of brushes to compensate for brush wear according to the measurement of the driving current and the preset schedule;
moving the pair of brushes from the first position to the second position; and
cleaning the workpiece with the pair of rolling brushes positioned at the second position.

9. The method of claim 8, wherein the workpiece is a wafer.

10. The method of claim 9, further receiving a measurement of the driving current utilized in processing a plurality of wafers, calculating an average of the received measurement, and determining the second position according to the average and the preset schedule.

11. The method of claim 8, further determining a standard driving current corresponding to a preset pressure exerted by the pair of brushes on the processed workpiece.

12. The method of claim 8, further performing a megasonic cleaning process on the workpiece.

13. The method of claim 8, further performing a chemical mechanical polishing (CMP) process on the workpiece.

14. The method of claim 8, further performing a drying process on the workpiece.

15. The method of claim 8, wherein the schedule specifies the relationship between the driving current and the distance between the outer surfaces of the first and second brushes.

16. A method for operating a brush assembly for wafer cleaning, wherein the brush assembly comprises a pair of brushes positioned at a first position, and the brush assembly rolls when performing wafer cleaning, comprising:
providing a preset schedule specifying relations between the driving current and the distance between the first and second brushes;
receiving a measurement of a driving current for rolling the brushes at the first position; and
determining a second position for the pair of brushes according to the measurement of the driving current and the preset schedule.

17. The method of claim 16, further receiving a measurement of the driving current utilized in processing a plurality of wafers, calculating an average of the received measurement, and determining the second position according to the average and the preset schedule.

18. The method of claim 16, further providing a standard driving current corresponding to a preset pressure exerted by the pair of brushes on the processed workpiece.

19. The method of claim 16, wherein the schedule specifies the relationship between the driving current and the distance between the outer surfaces of the first and second brushes.
